(19) United States
(12) Patent Application Publication
(10) Pub. No.: US 2016/0104921 A1
(43) Pub. Date: Apr. 14, 2016

(54) BATTERY MODULE

(71) Applicant: FORD GLOBAL TECHNOLOGIES, LLC, Dearborn, MI (US)

(72) Inventors: Steve F. Chorian, Canton, MI (US); Steve Droste, Ypsilanti, MI (US); Jesus Cardoso, Saline, MI (US)

(21) Appl. No.: 14/509,430

(22) Filed: Oct. 8, 2014

(51) Int. Cl. H01M 10/613; H01M 2/10

(52) U.S. Cl. CPC H01M 10/613; H01M 2/1077; H01M 10/625; H01M 10/6552; H01M 2220/20

(57) ABSTRACT

A battery module according to an exemplary aspect of the present disclosure includes, among other things, a housing having first and second vertical walls. Each of the first and second vertical walls including electrical connections.

### BACKGROUND

Electric vehicles, such as hybrid electric vehicles (HEVs), use electric machines instead of, or in addition to, an internal combustion engine. Electric vehicles are typically equipped with a battery pack containing multiple battery cells that store electrical power for powering an electric machine. In some known examples, the battery cells are contained within a housing. A thermal management system can direct a fluid, such as a liquid or air, in and out of the housing to cool the cells. In these examples, the housing may also include electrical connections for distributing power from the cells to the electric machine.

### SUMMARY

A battery module according to an exemplary aspect of the present disclosure includes, among other things, a housing having first and second vertical walls. Each of the first and second vertical walls including electrical connections.

In a further non-limiting embodiment of the foregoing battery module, the housing includes a base, and wherein each of the first and second vertical walls are end walls extending vertically upward from opposite ends of the base.

In a further non-limiting embodiment of the foregoing battery module, each of the first and second vertical walls includes a positive electrical terminal and a negative electrical terminal.

In a further non-limiting embodiment of the foregoing battery module, the battery module further includes a plurality of battery cells provided within the module.

In a further non-limiting embodiment of the foregoing battery module, the battery module further includes first and second bus bars. The positive electrical terminals and negative electrical terminals are electrically coupled to the battery cells by way of the first and second bus bars.

In a further non-limiting embodiment of the foregoing battery module, each of the first and second vertical walls includes at least one conduit.

In a further non-limiting embodiment of the foregoing battery module, the first vertical wall includes a pair of conduits, and wherein the second vertical wall includes a pair of conduits.

In a further non-limiting embodiment of the foregoing battery module, the housing includes a base, the first and second vertical walls extending vertically upward from the base.

In a further non-limiting embodiment of the foregoing battery module, the first and second vertical walls are end walls connected together by first and second side walls. The first and second side walls extend vertically upward from the base.

In a further non-limiting embodiment of the foregoing battery module, the first and second end walls and first and second side walls have a free end providing a lip.

In a further non-limiting embodiment of the foregoing battery module, the battery module further includes a cover attached to the housing adjacent the lip to enclose the module.

A system according to an exemplary aspect of the present disclosure includes, among other things, a first battery module having a housing including a vertical wall with electrical and thermal connections. The system further includes a second battery module having a housing including a vertical wall having electrical and thermal connections. The first and second battery modules are electrically and thermally coupled together by way of the respective electrical and thermal connections.

In a further non-limiting embodiment of the foregoing system, the electrical connections each include a positive electrical terminal and a negative electrical terminal.

In a further non-limiting embodiment of the foregoing system, the thermal connections each include at least one conduit.

In a further non-limiting embodiment of the foregoing system, the first battery module includes a first plurality of battery cells. The second battery module includes a second plurality of battery cells, and the first plurality of battery cells are electrically coupled to the second plurality of battery cells by way of the electrical connections.

In a further non-limiting embodiment of the foregoing system, the first battery module includes a first conduit and a second conduit, and wherein cooling fluid enters the first battery module by way of the first conduit and exits the first battery module by way of the second conduit.

In a further non-limiting embodiment of the foregoing system, the system further includes a source of cooling fluid. The first conduit is fluidly coupled to the source of cooling fluid.

In a further non-limiting embodiment of the foregoing system, the second battery module includes a third conduit and a fourth conduit. The fluid enters the second battery module by way of the third conduit and exits the second battery module by way of the fourth conduit.

In a further non-limiting embodiment of the foregoing system, the system is arranged such that fluid exiting the first battery module by way of the second conduit is directed into the second battery module by way of the third conduit.

In a further non-limiting embodiment of the foregoing system, the first battery module includes a cover, and the second battery module is stacked on the cover of the first battery module such that the second battery module is supported vertically above the first battery module.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE DRAWINGS

The drawings can be briefly described as follows:

FIG. 1 schematically illustrates a powertrain of a vehicle.

FIG. 2 is a perspective view of a first example battery module.

FIG. 3A is a side view of a first end wall of the battery module of FIG. 2.

FIG. 3B is a side view of a second end wall of the battery module of FIG. 2.

FIG. 4 is a sectional view illustrating two adjacent battery modules fluidly and electrically coupled to one another.

FIG. 5A illustrates a first end wall of a second example battery module.

FIG. 5B illustrates a second end wall of the second example battery module.

### DETAILED DESCRIPTION

This disclosure relates to a battery module for use in an electrified vehicle. The battery module includes both thermal and electrical connections in its vertical walls to facilitate connection between adjacent battery modules.

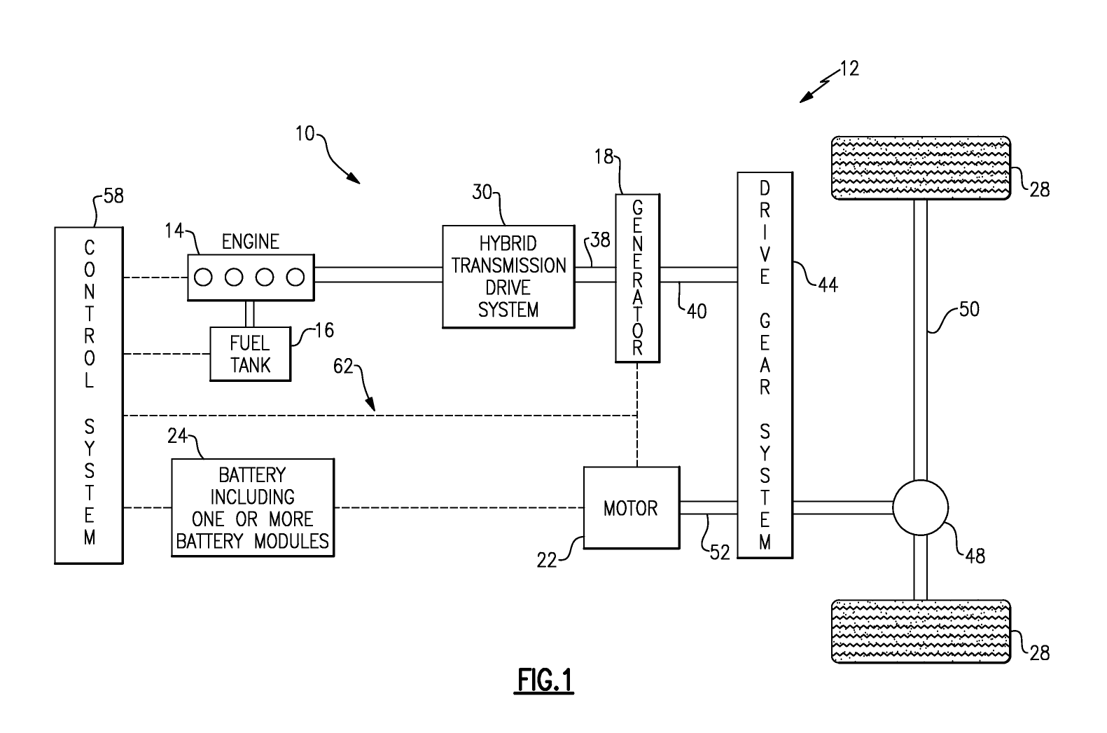

FIG. 1 schematically illustrates a powertrain of a vehicle 12, which, in this example, is an electrified vehicle. Although depicted as a hybrid electric vehicle (HEV), it should be understood that the concepts described herein are not limited to HEVs and could extend to other vehicles, including, but not limited to, plug-in hybrid electric vehicles (PHEVs), battery electric vehicles (BEVs), and modular hybrid transmission vehicles. This disclosure also extends to stop-start vehicles, vehicles powered only by an internal combustion engine (ICE), hydrogen vehicles (including both internal combustion and fuel cell hydrogen vehicles), natural gas vehicles, and propane vehicles, among others.

In one embodiment, the powertrain 10 is a powersplit powertrain system that employs a first drive system and a second drive system. The first drive system includes a combination of an engine 14 and a generator 18 (i.e., a first electric machine). The second drive system includes at least a motor 22 (i.e., a second electric machine), the generator 18, and a battery 24. In this embodiment, the second drive system is considered an electric drive system of the powertrain 10. The first and second drive systems generate torque to drive one or more sets of vehicle drive wheels 28 of the vehicle 12.

The engine 14, which is an internal combustion engine (ICE) in this embodiment, receives fuel, such as gasoline, from a fuel tank 16. Depending on the type of vehicle, fuels other than gasoline may be used. The engine 14 and the generator 18 may be connected through a power transfer unit 30, which in this example is a hybrid transmission gear system, such as a planetary gear set. Of course, other types of power transfer units, including other gear sets and transmissions, may be used to connect the engine 14 to the generator 18. In one non-limiting embodiment, the power transfer unit 30 is a planetary gear set that includes a ring gear, a sun gear, and a carrier assembly.

The generator 18 can be driven by the engine 14 through the power transfer unit 30 to convert kinetic energy to electrical energy. The generator 18 can alternatively function as a motor to convert electrical energy into kinetic energy, thereby outputting torque to a shaft 38 connected to the power transfer unit 30. Because the generator 18 is operatively connected to the engine 14, the speed of the engine 14 can be controlled by the generator 18.

The power transfer unit 30 may be connected to a shaft 40, which is connected to vehicle drive wheels 28 through a second power transfer unit 44, which in this example is a drive gear system. The second power transfer unit 44 may include a gear set having a plurality of gears. Other power transfer units may also be suitable. The second power transfer unit 44 transfers torque from the engine 14 to a differential 48 to ultimately provide traction to the vehicle drive wheels 28. The differential 48 may include a plurality of gears that enable the transfer of torque to the vehicle drive wheels 28. In one embodiment, the second power transfer unit 44 is mechanically coupled to an axle 50 through the differential 48 to distribute torque to the vehicle drive wheels 28.

The motor 22 (i.e., the second electric machine) can also be employed to drive the vehicle drive wheels 28 by outputting torque to a shaft 52 that is connected to the second power transfer unit 44. In one embodiment, the motor 22 and the generator 18 cooperate as part of a regenerative braking system in which both the motor 22 and the generator 18 can be employed as motors to output torque. For example, the motor 22 and the generator 18 can each output electrical power to the battery 24.

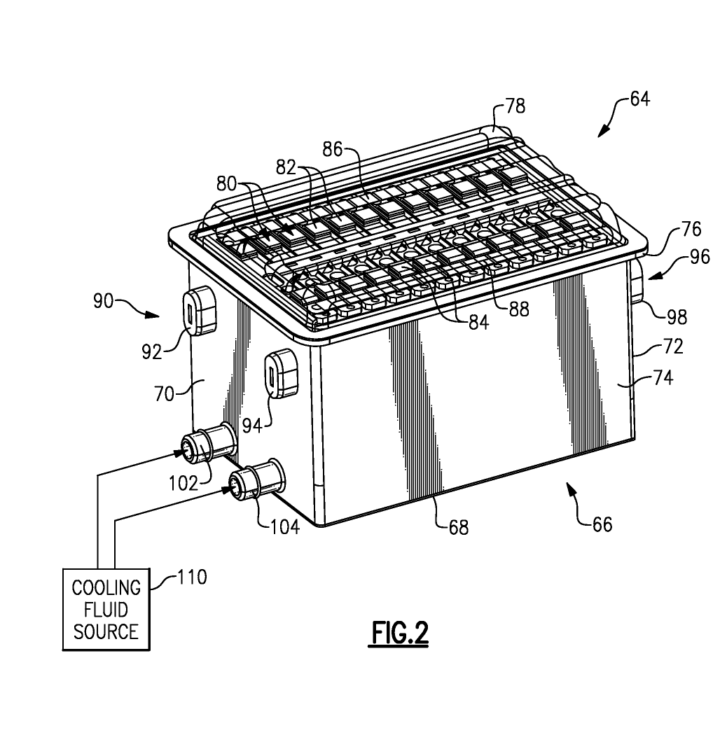

The battery 24 is one exemplary type of an electrified vehicle battery assembly and may take the form of a high voltage battery that is capable of outputting electrical power to operate the motor 22 and/or the generator 18. The battery 24 may include one or more battery modules 64 (FIG. 2) connected in parallel or in series, depending on the application. Other types of energy storage devices and/or output devices can also be used to supply power within the vehicle 12.

The powertrain 10 may additionally include a control system 58 (or, “controller”) for monitoring and/or controlling various aspects of the vehicle 12. For example, the control system 58 may communicate with the electric drive system, the power transfer units 30, 44, or other components to monitor the vehicle 12, control the vehicle 12, or both.

The control system 58 includes electronics, software, or both, to perform the necessary control functions for operating the vehicle 12. In one non-limiting embodiment, the control system 58 is a combination vehicle system controller and powertrain control module (VSC/PCM). Although it is shown as a single hardware device, the control system 58 may include multiple controllers in the form of multiple hardware devices, or multiple software controllers within one or more hardware devices. A controller area network (CAN) 62 allows the control system 58 to communicate with the various component of the vehicle 12.

One example battery module 64 (“battery module 64”) is illustrated in FIG. 2. The battery module 64 includes a housing 66 having a base 68 and opposed first and second end walls 70, 72 extending vertically upward from the base 68. The first and second end walls 70, 72 are connected together by side walls 74 (only one visible in FIG. 2), which also extend vertically upward from the base 68.

Opposite the base 68, the first and second end walls 70, 72 and the side walls 74 terminate at a free end, which, in this example, provides a lip 76. The lip 76 projects outward relative to the outer faces of the first and second end walls 70, 72 and the side walls 74. In this example, the lip 76 extends continuously about the perimeter of the housing 66.

The battery module 64 further includes a cover 78 attachable to the housing 66 adjacent the lip 76 in order to enclose the opening between the end walls 70, 72 and the side walls 74. In one example, the housing 66 (e.g., the base 68, first and second end walls, 70, 72, and side walls 74) is integrally formed as a single structural piece. The cover 78 is formed separately from the housing 66, and is attached to the housing 66 using a known technique. The housing 66 and the cover 78 may be formed of a metal, such as aluminum, in which case they could be welded together or connected using fasteners and sealant. This disclosure is not limited to any particular material type or connection between the housing 66 and the cover 78.

As illustrated, the cover 78 is transparent. A transparent material allows for visual inspection of the components within the battery module 64 without requiring removal of the cover 78. However, the cover 78 may be made of an opaque material.

As illustrated in FIG. 2, a plurality of battery cells (“cells”) 80 are positioned within the housing 66. The cells 80 may be held in place (i.e., secured) by a number of rails. The upper surface of each cell 80 supports two terminals 82, 84. In this example, the cells 80 are arranged such that the terminals 82, 84 are connected to bus bars 86, 88, respectively. In one example, the bus bars 86, 88 connect the cells 80 together in series. The cells 80 could be connected in parallel, however.

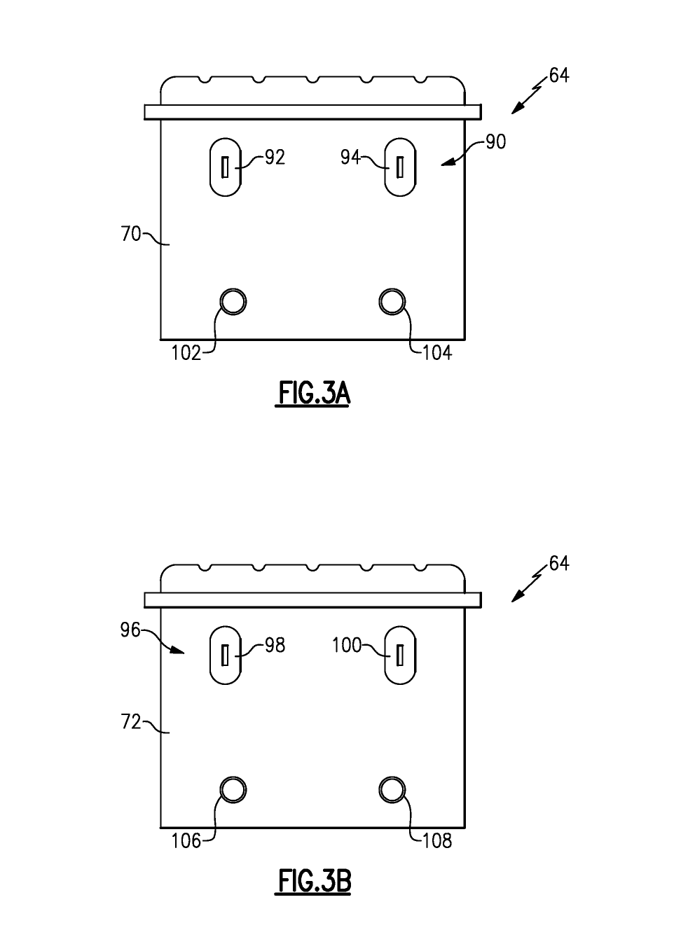

The bus bars 86, 88 are electrically coupled to a first positive and negative terminal pair (“terminal pair”) 90, which includes a first terminal 92 and a second terminal 94 incorporated into the first end wall 70. One of first and second terminals 92, 94 is a positive terminal, and the other is a negative terminal. In this example, the second end wall 72 also incorporates a terminal pair 96, which includes a third terminal 98 and a fourth terminal 100. The second terminal pair 96 is illustrated in FIG. 3B. Like the first terminal pair 90, one of the third and fourth terminals 98, 100 is positive terminal and the other is a negative terminal.

Each of the terminals 92, 94, 98, 100 includes an electrically conductive portion fitted with a mechanical connector. The electrically conductive portion electrically couples the terminals to the bus bars 86, 88, and the mechanical connector facilitates a mechanical connection.

As used in this disclosure, reference to the walls 70, 72 “including,” “incorporating,” or “being provided with” an electrical terminal means that at least a portion of the terminal is supported on, or extends through, the respective wall. In one example the walls 70, 72 are provided with an opening for an electrical connection to pass through the wall, and the connector may be fixed to an exterior of the walls 70, 72. In another example, the mechanical connectors are integrally formed with the respective end wall 70, 72.

The battery module 64 further includes a thermal management system. In one example, first and second conduits 102, 104 are incorporated into the first end wall 70 (FIG. 3A) and third and fourth conduits 106, 108 are incorporated into the second end wall 72 (FIG. 3B). The conduits 102, 104, 106, 108 could be integrally formed with the housing 66, or they could be formed separately from the housing 66 and later attached.

In one example, first and second conduits 102, 104 are fluidly coupled to a source of cooling fluid 110. The source of cooling fluid 110 may be a closed loop including one or more heat exchangers and a pump for pressurizing cooling fluid. The cooling fluid may be a liquid or gas (such as air).

In this example, cooling fluid is directed into the housing 66 via the first and second conduits 102, 104. The cooling fluid flows within the housing 66 to cool the cells 80. The housing 66 may include one or more internal flow paths, which may include one or more heat transfer features (such as fins) for cooling the cells 80.

In the example of FIGS. 2-3B, the cooling fluid passes through the housing 66 and exits the housing via the conduits 106, 108. While two conduits are shown in each of the first and second end walls 70, 72, the end walls 70, 72 could include one or more conduits.

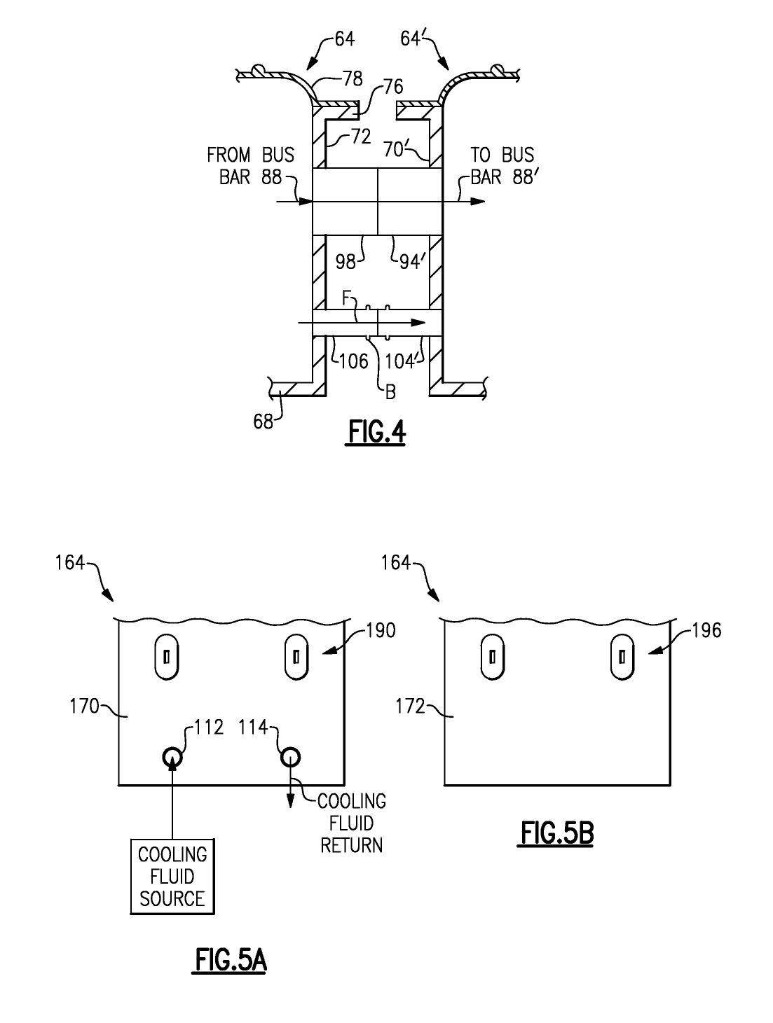

By providing each of the first and second end walls 70, 72 with electrical and thermal connections, the battery module 64 can be connected to an adjacent, similar battery module 64′, as illustrated in FIG. 4, by aligning the end walls of the two modules. It should be understood that this disclosure is not limited to connections between end walls, and extends to examples where the electrical and thermal connections are provided in side walls, or in other vertical walls.

With reference to FIG. 4, the adjacent battery module 64′ in this example is identical to the battery module 64. Like parts are illustrated in the drawings with a “prime” indicator. As illustrated, the terminal 98 on the second end wall 72 of the battery module 64 is connected to the terminal 94′ on the first end wall 70′ of the adjacent, similar battery module 64′. This provides an electrical connection between the bus bars 88, 88′ in the adjacent modules. Similarly, cooling fluid F from the source of cooling fluid 110 exits the battery module 64 by way of the conduit 106, and flows into the adjacent battery module 64′ by way of the conduit 104′ in the first end wall 70′. While not illustrated, there may be electrical and fluid connectors extending between the terminals 98, 94′ and the conduits 106, 104′, as necessary to complete the electrical and thermal connections. The conduits 106, 104′ may include a radially projecting bead B for cooperating with a thermal connector.

In FIG. 4 the battery modules 64, 64′ are horizontally aligned in substantially the same plane. However, in other examples, the battery modules 64, 64′ may be vertically stacked relative to one another. In those examples, the base 68′ of the battery module 64′ would be provided on the cover 78 of the battery module 64 such that the battery module 64′ is supported vertically above the battery module 64.

In the example of FIG. 4, the cooling fluid F is relatively warm as it enters the adjacent battery module 64′ by virtue of having already cooled the cells within the battery module 64. Thus, in some examples, the cooling fluid F does not flow serially between multiple modules. Instead, each module may include a dedicated cooling fluid inlet and outlet.

To the extent not otherwise described or shown, the module 164 of FIGS. 5A-5B corresponds to the battery module 64 of FIGS. 2-3B, with like parts having reference numerals preappended with a “1.”

As illustrated in FIGS. 5A and 5B, first and second end walls 170, 172 each include a positive and negative electrical terminal pair 190, 196, as in the embodiment of FIGS. 2-3B. In the example of FIGS. 5A and 5B, the first end wall 170 includes a first conduit 112 fluidly coupled to a source of cooling fluid 110, and also includes a second conduit 114 which serves as a cooling fluid exit. The conduit 114 directs cooling fluid to a cooling fluid return. The second conduit 114 need not be incorporated into the end wall 170, and instead may be incorporated into the opposite end wall 172, or one of the side walls. In this example, a system may include multiple of the modules 164, with each module being separately cooled.

This disclosure allows for consistency in the manufacture of battery modules. Based on power demands between vehicle lines, for example, one or more of the modules 64 can be incorporated into a particular vehicle. For instance, a Ford C-Max Hybrid may only use two modules 64, while a Ford Escape Hybrid may include four modules 64. Prior to this disclosure, separate modules would need to be manufactured for each vehicle line. Further, because the electrical and thermal connections are incorporated into the vertical walls of the modules, the modules can be easily coupled together, both electrically and fluidly.

It should be understood that terms such as “upward,” “inner,” and “outer” are used above with reference to the normal attitude of the battery module. These terms have been used herein for purposes of explanation, and should not be considered otherwise limiting.

Although the different examples have the specific components shown in the illustrations, embodiments of this disclosure are not limited to those particular combinations. It is possible to use some of the components or features from one of the examples in combination with features or components from another one of the examples.

One of ordinary skill in this art would understand that the above-described embodiments are exemplary and non-limiting. That is, modifications of this disclosure would come within the scope of the claims. Accordingly, the following claims should be studied to determine their true scope and content.

What is claimed is:

1. A battery module, comprising:
a housing having first and second vertical walls, each of the first and second vertical walls including electrical connections.

2. The battery module as recited in claim 1, wherein the housing includes a base, and wherein each of the first and second vertical walls are end walls extending vertically upward from opposite ends of the base.

3. The battery module as recited in claim 1, wherein each of the first and second vertical walls includes a positive electrical terminal and a negative electrical terminal.

4. The battery module as recited in claim 3, further comprising a plurality of battery cells provided within the module.

5. The battery module as recited in claim 4, further comprising first and second bus bars, wherein the positive electrical terminals and negative electrical terminals are electrically coupled to the battery cells by way of the first and second bus bars.

6. The battery module as recited in claim 1, wherein each of the first and second vertical walls includes at least one conduit.

7. The battery module as recited in claim 6, wherein the first vertical wall includes a pair of conduits, and wherein the second vertical wall includes a pair of conduits.

8. The battery module as recited in claim 1, wherein the housing includes a base, the first and second vertical walls extending vertically upward from the base.

9. The battery module as recited in claim 8, wherein the first and second vertical walls are end walls connected together by first and second side walls, wherein the first and second side walls extend vertically upward from the base.

10. The battery module as recited in claim 9, wherein the first and second end walls and first and second side walls have a free end providing a lip.

11. The battery module as recited in claim 10, further comprising a cover attached to the housing adjacent the lip to enclose the module.

12. A system, comprising:
a first battery module having a housing including a vertical wall with electrical and thermal connections; and
a second battery module having a housing including a vertical wall having electrical and thermal connections, the first and second battery modules electrically and thermally coupled together by way of the respective electrical and thermal connections.

13. The system as recited in claim 12, wherein the electrical connections each include a positive electrical terminal and a negative electrical terminal.

14. The system as recited in claim 12, wherein the thermal connections each include at least one conduit.

15. The system as recited in claim 12, wherein the first battery module includes a first plurality of battery cells, and wherein the second battery module includes a second plurality of battery cells, wherein the first plurality of battery cells are electrically coupled to the second plurality of battery cells by way of the electrical connections.

16. The system as recited in claim 12, wherein the first battery module includes a first conduit and a second conduit, and wherein cooling fluid enters the first battery module by way of the first conduit and exits the first battery module by way of the second conduit.

17. The system as recited in claim 16, further comprising a source of cooling fluid, wherein the first conduit is fluidly coupled to the source of cooling fluid.

18. The system as recited in claim 16, wherein the second battery module includes a third conduit and a fourth conduit, and wherein fluid enters the second battery module by way of the third conduit and exits the second battery module by way of the fourth conduit.

19. The system as recited in claim 18, wherein fluid exiting the first battery module by way of the second conduit is directed into the second battery module by way of the third conduit.

20. The system as recited in claim 12, wherein the first battery module includes a cover, and wherein the second battery module is stacked on the cover of the first battery module such that the second battery module is supported vertically above the first battery module.
